(19) United States
(12) Patent Application Publication
(10) Pub. No.: US 2011/0087703 A1
(43) Pub. Date: Apr. 14, 2011

(54) SYSTEM AND METHOD FOR DEEP ANNOTATION AND SEMANTIC INDEXING OF VIDEOS

(75) Inventors: Sridhar Varadarajan, Bangalore (IN); Sridhar Gangadharpalli, Bangalore (IN); Kiran Kalyan, Bangalore (IN)

(73) Assignee: SATYAM COMPUTER SERVICES LIMITED OF MAYFAIR CENTER, Secunderabad (IN)

(21) Appl. No.: 12/576,668

(22) Filed: Oct. 9, 2009

(51) Int. Cl. G06F 17/30

(52) U.S. Cl. 707/794; 707/E17.009; 707/E17.002; 707/741

(57) ABSTRACT

Video on demand services rely on frequent viewing and downloading of content to enhance the return on investment on such services. Videos in general and movies in particular hosted by video portals need to have extensive annotations to help in greater monetization of content. Such deep annotations help in creating content packages based on bits and pieces extracted from specific videos suited to individuals' queries thereby providing multiple opportunities for piece-wise monetization. Considering the complexity involved in extracting deep semantics for deep annotation based on video and audio analyses, a system and method for deep annotation uses video/movie scripts associated with content for supporting video-audio analysis in deep annotation.

### FIELD OF THE INVENTION

The present invention relates to video processing in general and more particularly movie processing. Still more particularly, the present invention is related to a system and method for deep annotation leading to semantic indexing of videos based on comprehensive analyses of video, audio, and associated script.

### BACKGROUND OF THE INVENTION

Video portals delivering content based services need to draw more users onto their portals in order to enhance revenue: one of the most practical ways to achieve this is to provide user interfaces that make users see the “bits & pieces” of content that are of their interest. Specifically, a movie as a whole is of interest in the initial stages of viewership; with time, different users need different portions of the movie wherein the portions could be based on scene details, actors involved, or dialogs. The users would want to query a video portal to get the relevant portions extracted from several of the videos and the extracted content packaged for to be delivered to the users. This requirement of users is a great boon for video on demand (VoD) service providers: there is an excellent commoditization and hence, monetization of small portions of the content. Such a micro-monetization is not uncommon on the web-based services: for example, in scientific publishing, there are several opportunities for micro-monetization such as (a) relevant tables and figures; and (b) experimental results associated with the various technical papers contained in a repository. In all such cases and all of the domains, deep annotation of the content helps in providing the most appropriate answers to the users' queries. Consider DVDs containing the movies: deep annotation of a movie offers an opportunity to deeply semantically index a DVD so that users could construct a large number of “video shows” based on their interests. Here, a video show is a packaged content based on “bits & pieces” of a movie contained in the DVD. An approach to achieve deep annotation of a video is to perform a combined analysis based on audio, video, and script associated with the video.

### DESCRIPTION OF RELATED ART

U.S. Pat. No. 7,467,164 to Marsh; David J. (Sammamish, Wash.) for “Media content descriptions” (issued on Dec. 16, 2008 and assigned to Microsoft Corporation (Redmond, Wash.)) describes a media content description system that receives media content descriptions from one or more metadata providers, associates each media content description with the metadata provider that provided the description, and may generate composite descriptions based on the received media content descriptions.

U.S. Pat. No. 7,457,532 to Barde; Sumedh N. (Redmond, Wash.), Cain; Jonathan M. (Seattle, Wash.), Janecek; David (Woodinville, Wash.), Terrell; John W. (Bothell, Wash.), Serbus; Bradley S. (Seattle, Wash.), Storm; Christina (Seattle, Wash.) for “Systems and methods for retrieving, viewing and navigating DVD-based content” (issued on Nov. 25, 2008 and assigned to Microsoft Corporation (Redmond, Wash.)) describes a system for enhancing a user's DVD experience by building a playlist structure shell based on a hierarchical structure associated with the DVD, and metadata associated with the DVD.

U.S. Pat. No. 7,448,021 to Lamkin; Allan (San Diego, Calif.), Collart; Todd (Los Altos, Calif.), Blair; Jeff (San Jose, Calif.) for “Software engine for combining video or audio content with programmatic content” (issued on Nov. 4, 2008 and assigned to Sonic Solutions, a California corporation (Novato, Calif.)) describes a system for combining video/audio content with programmatic content, generating programmatic content in response to the searching, and generating an image as a function of the programmatic content and the representation of the audio/video content.

U.S. Pat. No. 7,366,979 to Spielberg; Steven (Los Angeles, Calif.), Gustman; Samuel (Universal City, Calif.) for “Method and apparatus for annotating a document” (issued on Apr. 29, 2008 and assigned to Copernicus Investments, LLC (Los Angeles, Calif.)) describes an apparatus for annotating a document that allows for the addition of verbal annotations to a digital document such as a movie script, book, or any other type of document, and further the system stores audio comments in data storage as an annotation linked to a location in the document being annotated.

“Movie/Script: Alignment and Parsing of Video and Text Transcription” by Cour; Timothee, Jordan; Chris, Miltsakaki; Eleni, and Taskar; Ben (appeared in the Proceedings of the 10th European Conference on Computer Vision (ECCV 2008), Oct. 12-18, 2008, Marseille, France) describes an approach in which scene segmentation, alignment, and shot threading are formulated as a unified generative model, and further describes a hierarchical dynamic programming algorithm that handles alignment and jump-limited reordering in linear time.

“A Video Movie Annotation System-Annotation Movie with its Scrip” by Zhang; Wenli, Yaginuma; Yoshitomo; and Sakauchi; Masao (appeared in the Proceedings of WCCC-ICSP 2000. 5th International Conference on Signal Processing, Volume 2, Page(s):1362-1366) describes a movie annotation method for synchronizing a movie with its script based on dynamic programming matching and a video movie annotation system based on this method.

The known systems do not address about how to bootstrap deep annotation of videos based video and script analyses. A bootstrapping process allows for errors in the initial stages of the analyses and at the same time achieves enhanced accuracy towards the end. In the bootstrapping process, it is important to have as much of possible coarse-grained annotation of a video as possible so that the error in script alignment is minimized and the effectiveness of the deep annotation is enhanced. The present invention provides for a system and method to use the script associated with a video in the coarse-grained annotation of the video, and uses the coarse-grained annotation along with the script to generate the fine-grained annotation (that is, deep annotation) of the video.

### SUMMARY OF THE INVENTION

The primary objective of the invention is to associate deep annotation and semantic index with a video/movie.

One aspect of the invention is to exploit the script associated with a video/movie.

Another aspect of the invention is to analyze the script to identify a closed-world set of key-phrases.

Yet another aspect of the invention is to perform coarse-grained annotation of a video based on the closed-world set of key-phrases.

Another aspect of the invention is to perform coarse-grained annotation of a script.

Yet another aspect of the invention is to map a key frame of a video scene to one or more script segments based on the coarse-grained annotation of the key frame and the coarse-grained annotation of script segments.

Another aspect of the invention is to identify the best possible script segment to be mapped onto a video scene.

Yet another aspect of the invention is to analyze the script segment associated with a video scene to achieve a fine-grained annotation of the video scene.

Another aspect of the invention is to identify homogeneous video scenes based on the fine-grained annotation of the video scenes of a video.

### BRIEF DESCRIPTION OF THE DRAWINGS

FIG. 1 provides an overview of a video search and retrieval system.

FIG. 2 depicts an illustrative script segment.

FIG. 3 provides illustrative script and scene structures.

FIG. 3a provides additional information about script and scene structures.

FIG. 4 provides an approach for closed-world set identification.

FIG. 5 provides an approach for enhancing script segments.

FIG. 6 provides an approach for coarse-grained annotation of script segments.

FIG. 7 depicts an approach for video scene identification and coarse-grained annotation.

FIG. 7a provides illustrative annotations.

FIG. 8 depicts an overview of deep indexing of a video.

FIG. 8a depicts an approach for deep indexing of a video.

FIG. 9 provides an approach for segment-scene mapping.

FIG. 9a depicts an illustrative segment mapping.

FIG. 10 provides an approach for video scene annotation.

FIG. 11 depicts the identification of homogeneous video scenes.

### DETAILED DESCRIPTION OF THE PREFERRED EMBODIMENTS

Deep annotation and semantic indexing of videos/movies help in providing enhanced and enriched access to content available on web. While this is so, the deep annotation of videos to give access to “bits & pieces” of content poses countless challenges. On the other hand, there has been tremendous work on the shallow annotation of videos although there has not been a great success even at this level. An approach is to exploit any and all of the additional information that is available along with a movie. One such information base is the movie script: The script provides detailed and necessary information about the movie under making; that is, the script is prepared much before the movie shooting. Because of this factor, the script and the made movie may not correspond with each other; that is, the script and the movie may not match one to one. Additionally, it should be noted that the script, from the point of view of the movie, could be outdated, incomplete, and inconsistent. This poses a big challenge in using the textual description of the movie contained in the script. This means that independent video processing is complex and at the same time, independent script processing is also complex. A way to address this two-dimensional complexity is to design a system that bootstraps through incremental analyses.

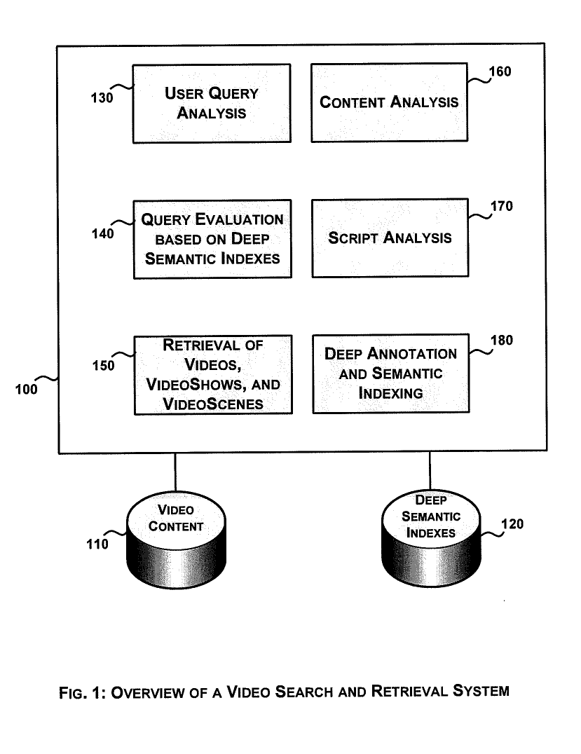

FIG. 1 provides an overview of a video search and retrieval system. A video search and retrieval system (100) helps in searching of a vast collection of video (110) and provides access to the videos of interest to users. An extremely user friendly interface gets provided when there is a deep and semantic indexing (120) of the videos. The input user query is analyzed (130), the analyzed query is evaluated based on deep and semantic indexes (140). The result of the query evaluation is in the form of (a) videos; (b) video shows (portions of videos stitched together); and (c) video scenes (150). In order to be able to build deep annotation, the content is analyzed (160), the script associated with each of the videos is analyzed (170), and based on these two kinds of analyses, deep annotation of content is determined (180). Using the deep annotation, it is a natural next step to build semantic indexes for the videos contained in the content database.

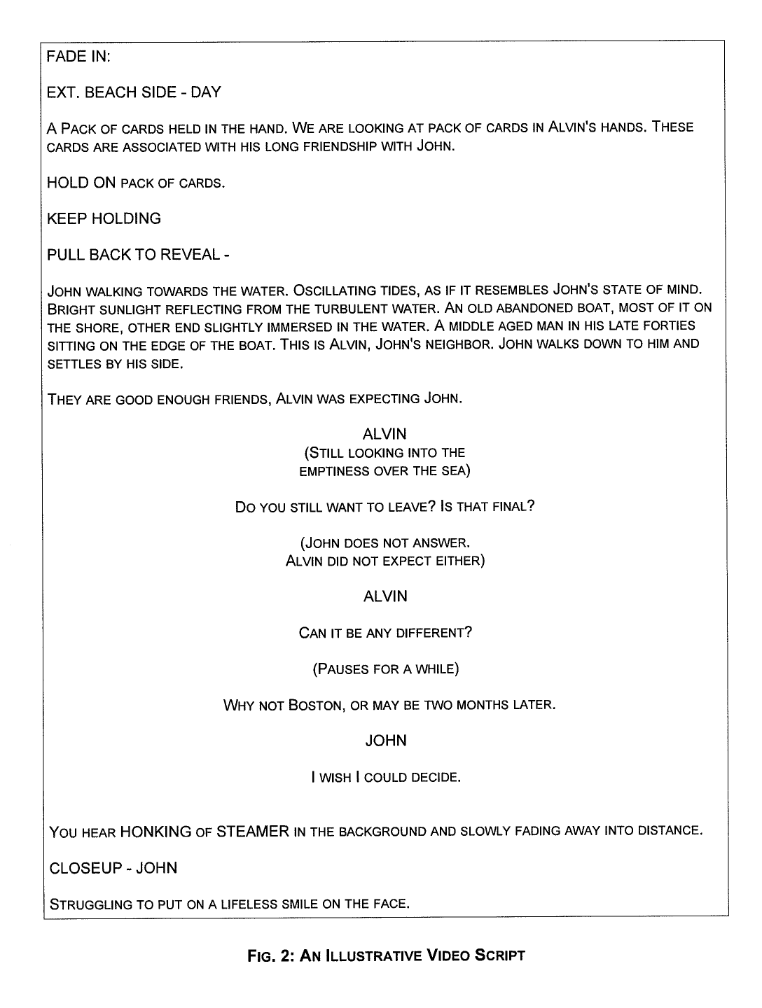

FIG. 2 depicts an illustrative script segment. Note that the provided illustrative script segment highlights the various key aspects such as the structural components and their implicit interpretation.

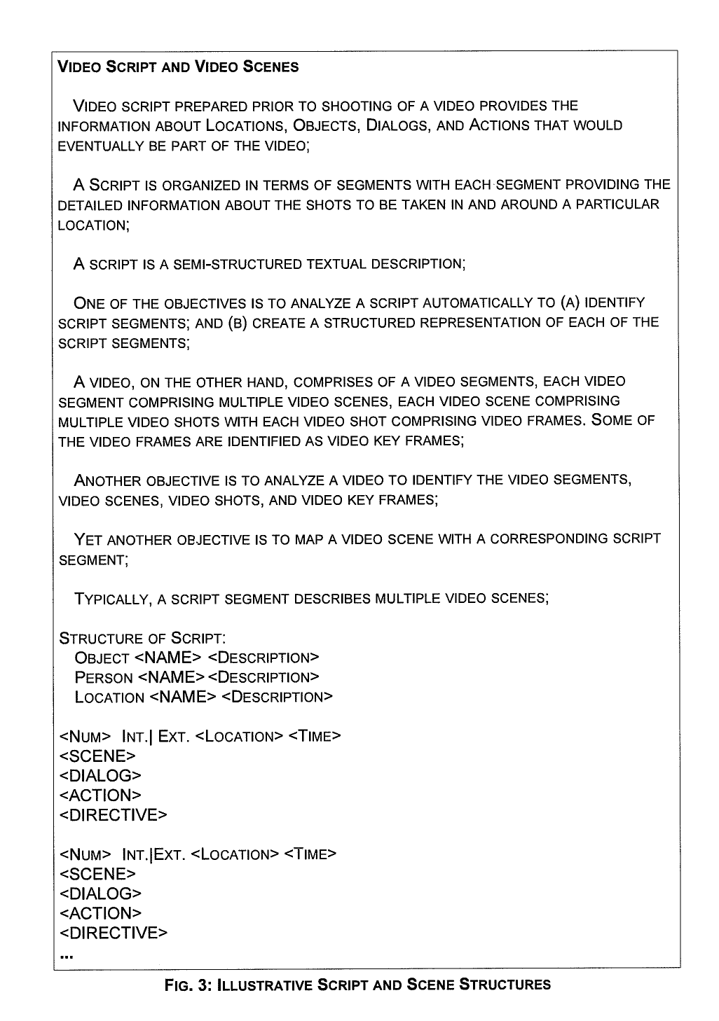

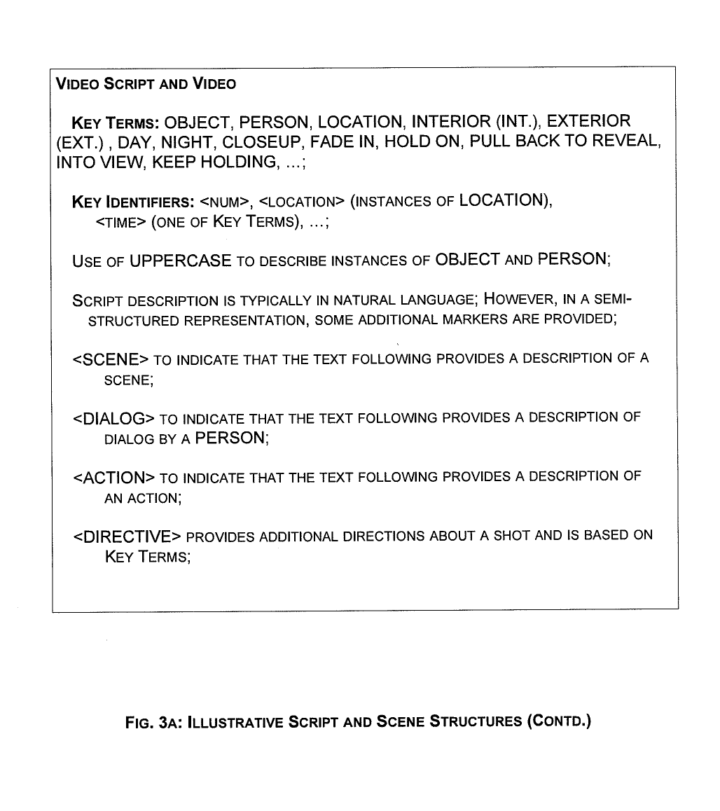

FIG. 3 provides an illustrative script and scene structures.

A video script provides information about a video and is normally meant for to be understood by human beings (for example, shooting crew members) in order to effectively shoot a video.
Video script prepared prior to shooting of a video provides the information about Locations, Objects, Dialogs, and Actions that would eventually be part of the video;
A Script is organized in terms of segments with each segment providing the detailed information about the shots to be taken in and around a particular location;
A script is a semi-structured textual description;
One of the objectives is to analyze a script automatically to (a) identify script segments; and (b) create a structured representation of each of the script segments;
A video, on the other hand, comprises of a video segments, each video segment comprising multiple video scenes, each video scene comprising multiple video shots with each video shot comprising video frames. Some of the video frames are identified as video key frames;
Another objective is to analyze a video to identify the video segments, video scenes, video shots, and video key frames;
Yet another objective is to map a video scene with a corresponding script segment;
Typically, a script segment describes multiple video scenes;

### Structure of Script:

Object <NAME> <Description>
Person <NAME> <Description>
Location <NAME> <Description>

| <Num> | Int.\| Ext. <Location> <Time> |
|---|---|
| <SCENE> | |
| <DIALOG> | |
| <ACTION> | |
| <DIRECTIVE> | |
| <Num> | Int.\|Ext. <Location> <Time> |

<SCENE>
<DIALOG>
<ACTION>
<DIRECTIVE>
...

FIG. 3a provides additional information about script and scene structures.

A video script is based on a set of Key Terms that provide a list of a sort of reserved words with a pre-defined semantics. Similarly, Key Identifiers provide certain placeholders in the script structure for to be filled in appropriately during the authoring of a script.
Key Terms: OBJECT, PERSON, LOCATION, INTERIOR (NT.), EXTERIOR

(EXT.), DAY, NIGHT, CLOSEUP, FADE IN, HOLD ON, PULL BACK TO REVEAL, INTO VIEW, KEEP HOLDING, . . . ;
Key Identifiers: <num>, <location> (instances of LOCATION), <time> (one of Key Terms), . . . ;
Use of UPPERCASE to describe instances of OBJECT and PERSON;
Script description is typically in natural language; However, in a semi-structured representation, some additional markers are provided;
<SCENE> to indicate that the text following provides a description of a scene;
<DIALOG> to indicate that the text following provides a description of dialog by a PERSON;
<ACTION> to indicate that the text following provides a description of an action;
<DIRECTIVE> provides additional directions about a shot and is based on Key Terms;

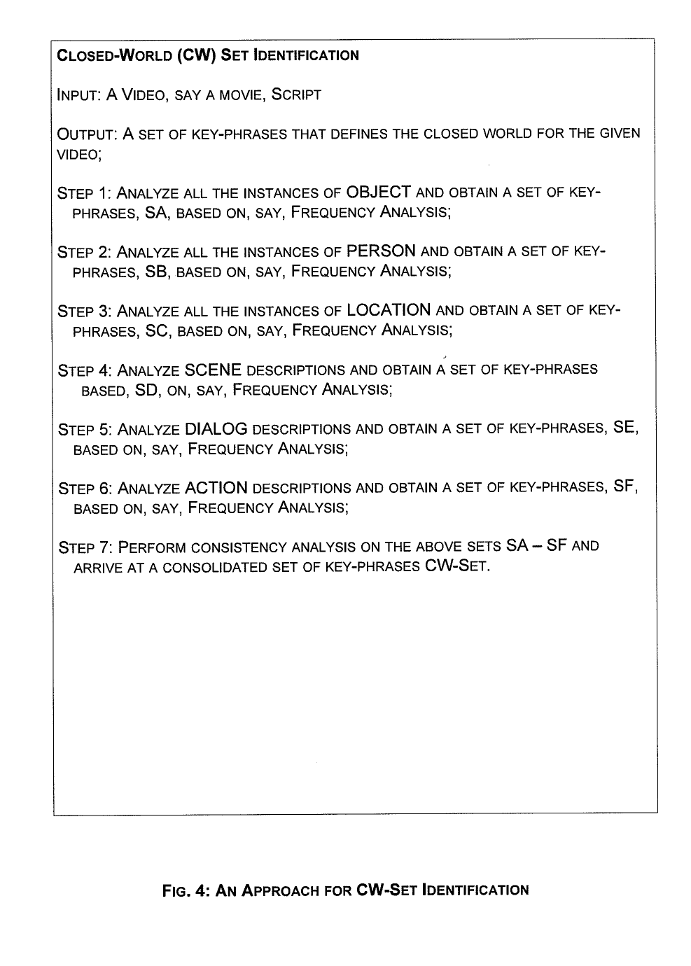

FIG. 4 provides an approach for closed-world set identification. In the process of bootstrapping of deep annotation and semantic indexing, it is essential to perform incremental analysis using a video and the corresponding script. As a first step, it is essential to identify a set of key-phrases based on the given script. This set of key-phrases forms the basis for the video analysis of the video using multimedia processing techniques.

### Closed-World (CW) Set Identification

Input: A Video, say a movie, Script
Output: A set of key-phrases that defines the closed world for the given video;
Step 1: Analyze all the instances of OBJECT and obtain a set of key-phrases, SA, based on, say, Frequency Analysis;
Step 2: Analyze all the instances of PERSON and obtain a set of key-phrases, SB, based on, say, Frequency Analysis;
Step 3: Analyze all the instances of LOCATION and obtain a set of key-phrases, SC, based on, say, Frequency Analysis;
Step 4: Analyze SCENE descriptions and obtain a set of key-phrases based, SD, on, say, Frequency Analysis;
Step 5: Analyze DIALOG descriptions and obtain a set of key-phrases, SE, based on, say, Frequency Analysis;
Step 6: Analyze ACTION descriptions and obtain a set of key phrases, SF, based on, say, Frequency Analysis;
Step 7: Perform consistency analysis on the above sets SA-SF and arrive at a consolidated set of key phrases CW-Set.

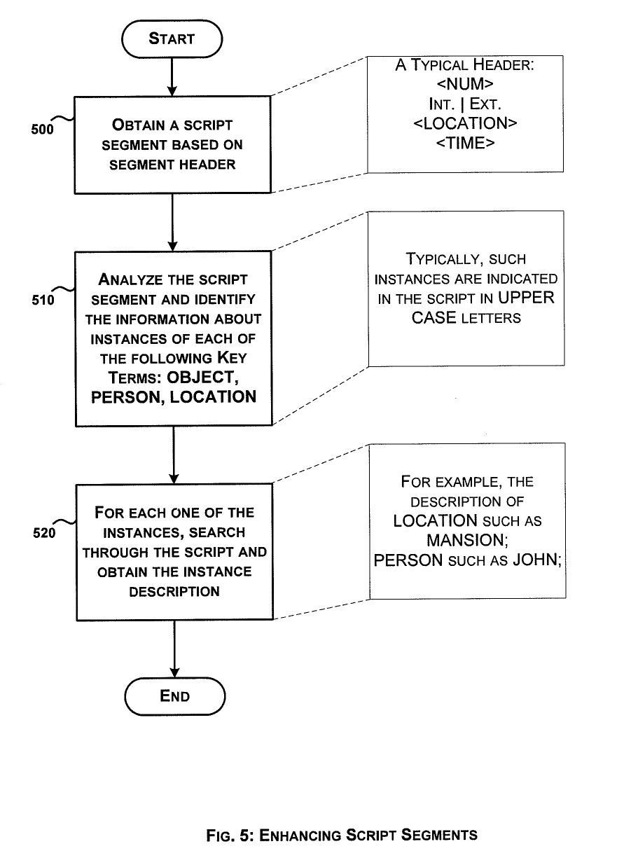

FIG. 5 provides an approach for enhancing script segments. In a parsimonious representation of a script, typically, the descriptions may not be duplicated. Alternatively, entities are named, described once, and are referred wherever appropriate. However, in order to process the script segments efficiently, as an intermediate step, it is useful to derive a self-contained script segments. Obtain a script segment based on segment header (500). A typical header includes <NUM> Int.|Ext. <LOCATION> and <TIME> based entities. Analyze the script segment and identify the information about instances of each of the following Key Terms: OBJECT, PERSON, LOCATION (510). Typically, such instances are indicated in the script in UPPER CASE letters. For each one of the instances, search through the script and obtain the instance description (520). For example, the description of LOCATION such as MANSION and PERSON such as JOHN.

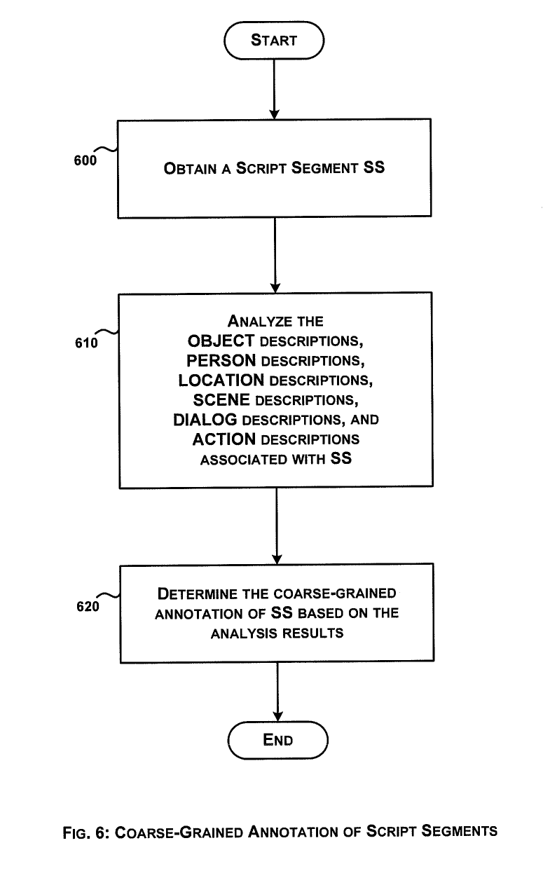

FIG. 6 provides an approach for coarse-grained annotation of script segments. In order to effectively bootstrap, it is equally essential to achieve coarse-grained annotation of the script segments. Obtain a script segment SS (600). Analyze the OBJECT descriptions, PERSON descriptions, LOCATION descriptions, SCENE descriptions, DIALOG descriptions, and ACTION descriptions associated with SS (610). In order to obtain a coarse-grained annotation, a textual analysis, say, involving term-frequency is sufficient. Determine the coarse-grained annotation of SS based on the analysis results (620).

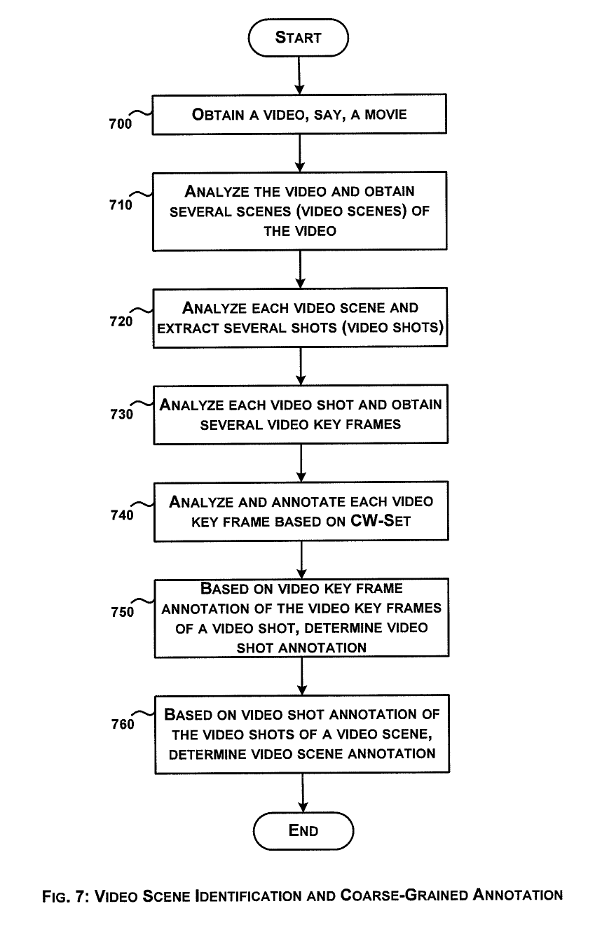

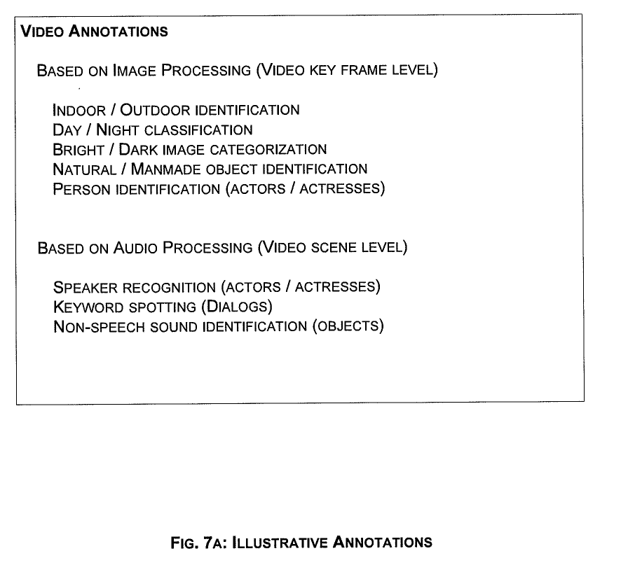

FIG. 7 depicts an approach for video scene identification and coarse-grained annotation. The next step in the bootstrapping processing is to analyze a video to arrive at a coarse-grained annotation of the video. Obtain a video, say, a movie (700). Analyze the video and obtain several scenes (video scenes) of the video (710). Analyze each video scene and extract several shots (video shots) (720). Analyze each video shot and obtain several video key frames (730). Note that the above analyses are based on the well known structure of a video: segments, scenes, shots, and frames. There are several well established techniques described in the literature to achieve each of these analyses. Analyze and annotate each video key frame based on CW-Set (740). The closed-world set, CW-Set, plays an important role in the analysis of a key frame leading to a more accurate identification of objects in the key frame and hence, better annotation of the key frame. USPTO application titled “System and Method for Hierarchical Image Processing” by Sridhar Varadarajan, Sridhar Gangadharpalli, and Adhipathi Reddy Aleti (under filing process) describes an approach for exploiting CW-Set to achieve better annotation of a key frame. Based on video key frame annotation of the video key frames of a video shot, determine video shot annotation (750). There are multiple well known techniques described in the literature to undertake a multitude of analyses of a multimedia content, say, based on audio, video, and textual portion of the multimedia content. U.S. patent application Ser. No. 12/194,787 titled “System and Method for Bounded Analysis of Multimedia using Multiple Correlations” by Sridhar Varadarajan, Amit Thawani, and Kamakhya Gupta (assigned to Satyam Computer Services Ltd. (Hydreabad, India)) describes an approach for annotating of the multimedia content in a maximally consistent manner based on such a multitude of analyses of the multimedia content. Based on video shot annotation of the video shots of a video scene, determine video scene annotation (760). U.S. patent application Ser. No. 12/199,495 titled “System and Method for Annotation Aggregation” by Sridhar Varadaraj an, Srividya Gopalan, Amit Thawani (assigned to Satyam Computer Services Ltd. (Hydreabad, India)) describes an approach that uses the annotation at a lower level to arrive at an annotation at the next higher level.

FIG. 7a provides illustrative annotations.

Video analysis to arrive annotations makes use of multiple techniques, some are based on image processing, some are based on text processing, and some are on audio processing.
Based on Image Processing (Video key frame level)
   Indoor/Outdoor identification
   Day/Night classification
   Bright/Dark image categorization
   Natural/Manmade object identification
   Person identification (actors/actresses)
Based on Audio Processing (Video scene level)
   Speaker recognition (actors/actresses)
   Keyword spotting (Dialogs)
   Non-speech sound identification (objects)

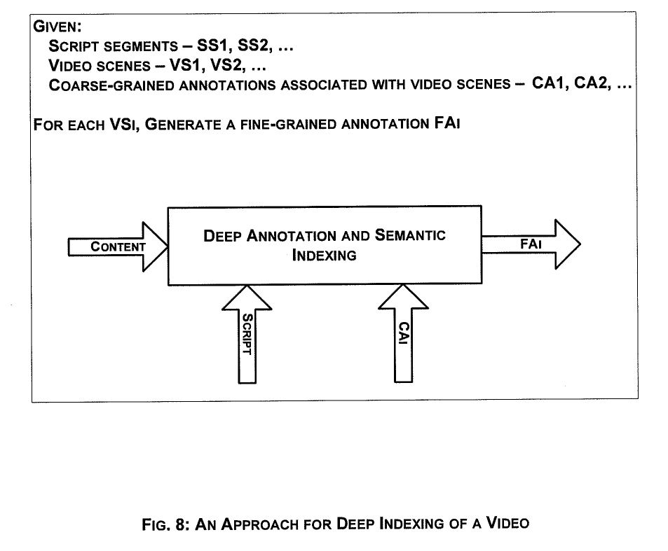

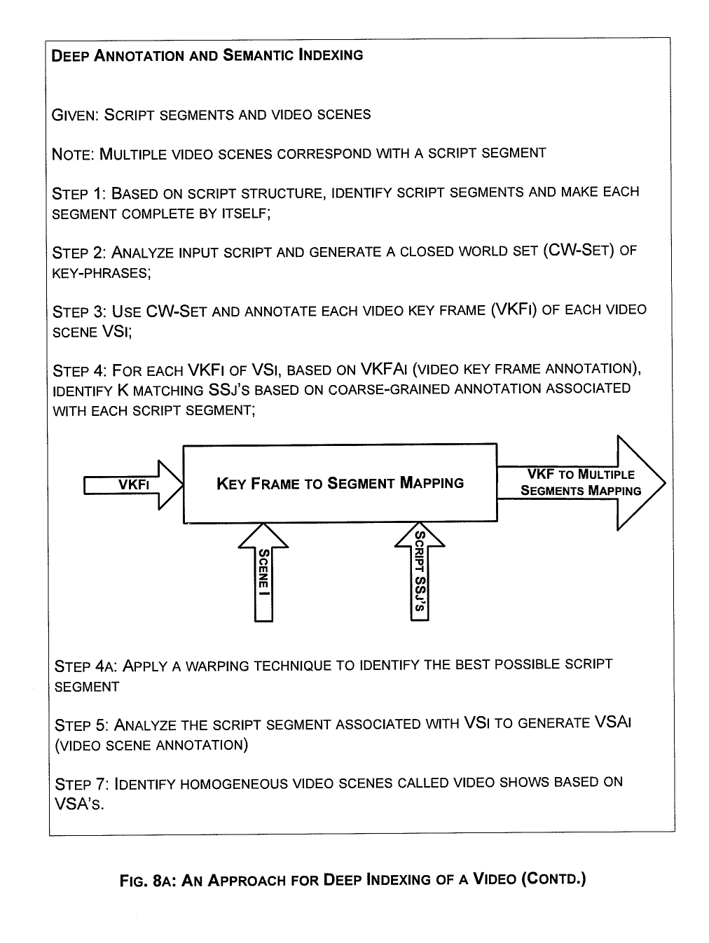

FIG. 8 depicts an overview of deep indexing of a video.

Given:
Script segments—SS1, SS2, . . .
Video scenes—VS1, VS2, . . .
Coarse-grained annotations associated with video scenes—CA1, CA2, . . .

For each scene VSi, Generate a fine-grained annotation FAi

The process of deep annotation receives a content described in terms of a set of video scenes as input and uses the script described in terms of a set of script segments which is associated with the content and a set of coarse-grained annotations associated the set of video scenes to arrive at a fine-grained annotation for each of the video scenes.

FIG. 8a depicts an approach for deep indexing of a video.

Deep Annotation and Semantic Indexing

Given: Script segments and video scenes
Note: Multiple video scenes correspond with a script segment
Step 1: Based on script structure, identify script segments and make each segment complete by itself;
Step 2: Analyze input script and generate a closed world set (CW-Set) of key-phrases;
Step 3: Use CW-Set and annotate each video key frame (VKFi) of each video scene VSi;
Step 4: For each VKFi of VSi, based on VKFAi (video key frame annotation), identify K matching script segments (SSj's) based on coarse-grained annotation associated with each script segment. This step accounts for both inaccuracy in the coarse-grained annotation and outdatedness of the script.
Step 4a: Apply a warping technique to identify the best possible script segment that matches with most of the key frames of the video scene VSi.
Step 5: Analyze the script segment associated with VSi to generate VSAi (video scene annotation). Note that this step employs a multitude of semi-structured text processing to arrive at an annotation of the video scene.
Step 7: Identify homogeneous video scenes called video shows based on VSA's. A typical way to achieve this is to use a clustering technique based on the annotation of the video scenes. The identified clusters tend to identify video scenes that have similar annotations and hence, the corresponding scenes are also similar as well.

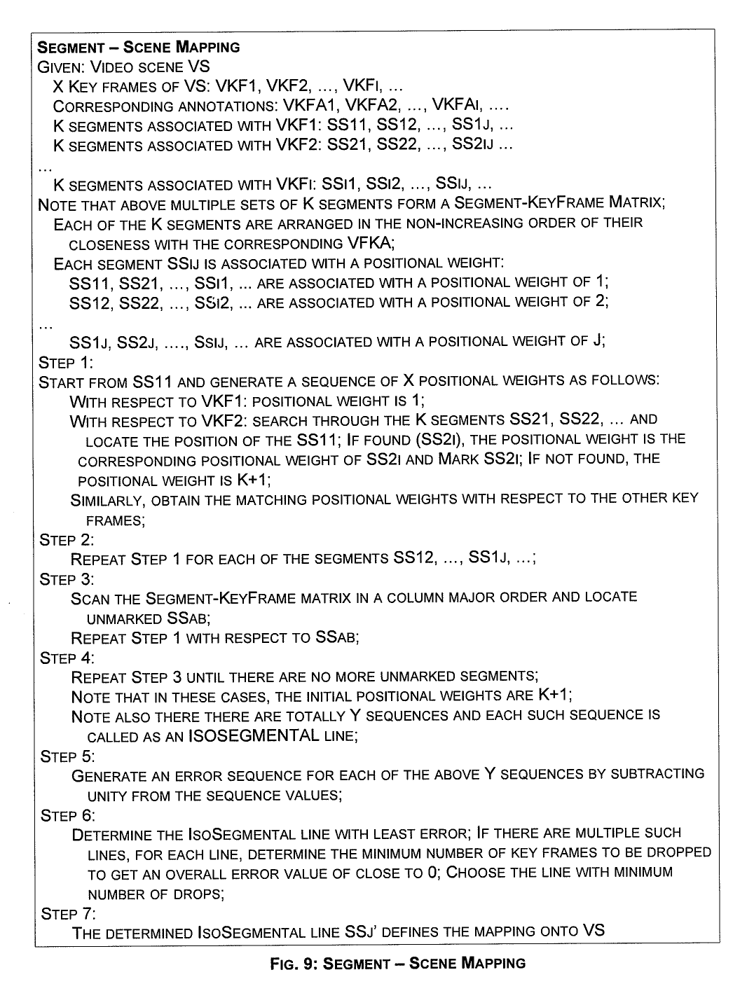

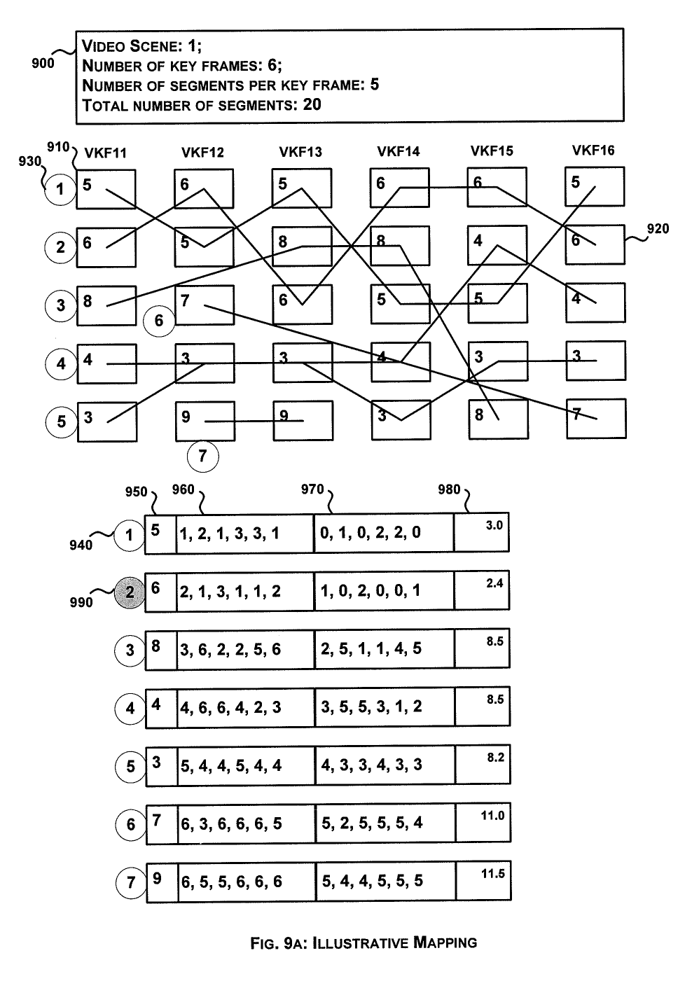

FIG. 9 provides an approach for segment-scene mapping.

### Segment-Scene Mapping

Given: Video scene VS
X Key frames of VS: VKF1, VKF2, . . . , VKFi, . . .
Corresponding annotations: VKFA1, VKFA2, . . . , VKFAi, . . .
K segments associated with VKF1: SS11, SS12, . . . , SS1j, . . .
K segments associated with VKF2: SS21, SS22, . . . , SS2ij . . .
. . .
K segments associated with VKFi: SSi1, SSi2, . . . , SSij, . . .
   Note that above multiple sets of K segments form a Segment-KeyFrame Matrix;
Each of the K segments are arranged in the non-increasing order of their closeness with the corresponding VFKA; Note that the key frame annotations are matched with the script segments, wherein each of the script segments is also described in manner so as to be able to match with the key frame annotations. In one of the embodiments, text processing techniques are used on the semi-structured script segment to arrive at a suitable coarse-grained annotation.
Each segment SSij is associated with a positional weight:
   SS11, SS21, . . . , SSi1, . . . are associated with a positional weight of 1;
   SS12, SS22, . . . , SSi2, . . . are associated with a positional weight of 2;
   SS1j, SS2j, . . . , Ssij, . . . are associated with a positional weight of J;

### Step 1:

Start from SS11 and generate a sequence of X positional weights as follows:
With respect to VKF1: positional weight is 1;
With respect to VKF2: search through the K segments SS21, SS22, . . . and locate the position of the SS11; If found (SS2i), the positional weight is the corresponding positional weight of SS2i and Mark SS2i; If not found, the positional weight is K+1;
Similarly, obtain the matching positional weights with respect to the other key frames;

### Step 2:

Repeat Step 1 for each of the segments SS12, . . . , SS1j, . . . ;

### Step 3:

Scan the Segment-KeyFrame matrix in a column major order and locate unmarked SSab;
Repeat Step 1 with respect to SSab;

### Step 4:

Repeat Step 3 until there are no more unmarked segments;
Note that in these cases, the initial positional weights are K+1;
Note also there are totally Y sequences and each such sequence is called as an ISOSEGMENTAL line;

### Step 5:

Generate an error sequence for each of the above Y sequences by subtracting unity from the sequence values;

### Step 6:

Determine the IsoSegmental line with least error; If there are multiple such lines, for each line, determine the minimum number of key frames to be dropped to get an overall error value of close to 0; Choose the line with minimum number of drops;

### Step 7:

The determined IsoSegmental line SSj' defines the mapping onto VS;

FIG. 9a depicts an illustrative segment mapping. For illustrative purposes, consider the following (900):

Video Scene: 1; VS1 is the video scene.
Number of key frames: 6; VKF11, VKF12, VKF13, VKF14, VKF15, and VKF16 are the illustrative key frames.
Number of segments per key frame: 5; That is, the top 5 of the matched segments are selected for further analysis.
Total number of segments: 20

910 depicts the best matched segment (SS 5) with respect to the key frame VKF11 while 920 depicts the second best matched segment (SS 6) with respect to the key frame VKF16. There are totally 7 IsoSegmental lines and 930 depicts first of them. 940 depicts the various computations associated with the first IsoSegmental line. 950 indicates the script segment number (SS 5), 960 indicates the positional weight sequence, 970 depicts the associated error sequence, and 980 provides the error value. Based on the error value associated with the 7 IsoSegmental lines, the IsoSegmental line 2 with the least error is selected as the best matched segment (SS 6) for mapping onto VS1.

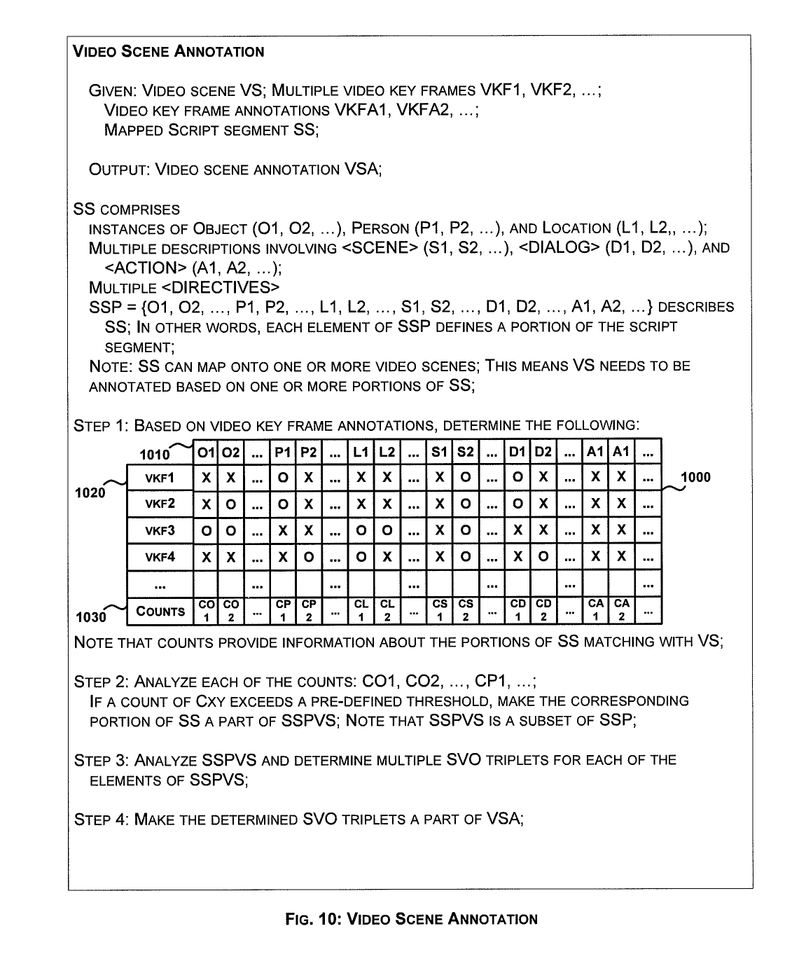

FIG. 10 provides an approach for video scene annotation. The approach uses the description of the portions of the script segment that matches best with a video scene.

### Video Scene Annotation

Given:
   Video scene VS; Multiple video key frames VKF1, VKF2, . . . ;
   Video key frame annotations VKFA1, VKFA2, . . . ;
   Mapped Script segment SS;
Output: Video scene annotation VSA;
   SS comprises
instances of Object (O1, O2, . . . ), Person (P1, P2, . . . ), and Location (L1, L2, . . . );
Multiple descriptions involving <SCENE> (S1, S2, . . . ), <DIALOG> (D1, D2, . . . ), and <ACTION> (A1, A2, . . . );
Multiple <DIRECTIVES>
As a consequence, a script segment is described in terms of these multiple instances and multiple descriptions as follows:
SSP={O1, O2, . . . , P1, P2, . . . , L1, L2, . . . , S1, S2, . . . , D1, D2, . . . , A1, A2, . . . } describes SS; In other words, each element of SSP defines a portion of the script segment;
Note: SS can map onto one or more video scenes; This means that VS needs to be annotated based on one or more portions of SS;
   Step 1: Based on video key frame annotations, determine the matching of the various portions of SSP with respect to the key frames of VS (1000): For example, 1010 depicts how a portion of SS based on the description of an instance of Object O1 matches with the various key frames; here, “O” denotes a good match while “X” denotes not so much of a good match; similarly, 1020 depicts how a key frame matches with the various portions of SS. 1030 depicts the counts indicating how well each of the portions of SS matches with respect to all of the key frames. Note that the counts provide information about the portions of SS matching with VS;
   Step 2: Analyze each of the counts: CO1, CO2, . . . , CP1, . . . ;
   If a count of Cxy exceeds a pre-defined threshold, make the corresponding portion of SS a part of SSPVS; Note that SSPVS is a subset of SSP;
      Step 3: Analyze SSPVS and determine multiple SVO triplets for each of the elements of SSPVS; Note that the portions of a script segment are described typically in a natural language such as English. Here, an SVO triplet stands for <Subject, Verb, Object> that is part of any sentence of a portion of the script segment. The natural language analysis is greatly simplified by the fact the scripts provide positive descriptions.
      Step 4: Make the determined SVO triplets a part of VSA;

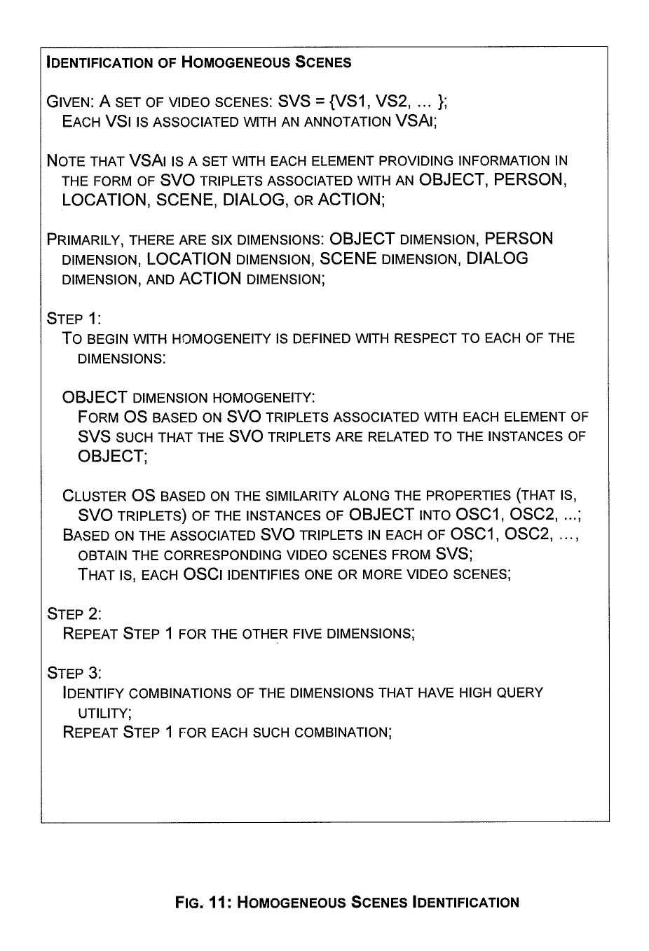

FIG. 11 depicts the identification of homogeneous video scenes.

### Identification of Homogeneous Scenes

### Given:

A set of video scenes: SVS={VS1, VS2, . . . };
Each VSi is associated with an annotation VSAi;

Note that VSAi is a set with each element providing information in the form of SVO triplets associated with an OBJECT, PERSON, LOCATION, SCENE, DIALOG, or ACTION;

Primarily, there are six dimensions: OBJECT dimension, PERSON dimension, LOCATION dimension, SCENE dimension, DIALOG dimension, and ACTION dimension;

### Step 1:

To begin with homogeneity is defined with respect to each of the dimensions: OBJECT dimension homogeneity:
   Form OS based on SVO triplets associated with each element of SVS such that the SVO triplets are related to the instances of OBJECT;
   Cluster OS based on the similarity along the properties (that is, SVO triplets) of the instances of OBJECT into OSC1, OSC2, . . . ;
   Based on the associated SVO triplets in each of OSC1, OSC2, . . . , obtain the corresponding video scenes from SVS;
      That is, each OSCi identifies one or more video scenes;

### Step 2:

Repeat Step 1 for the other five dimensions;

### Step 3:

Identify combinations of the dimensions that have high query utility;
Repeat Step 1 for each such combination;

In order to identify homogeneous scenes, two things are essential: one is a homogeneity factor and the second thing is a similarity measure. The homogeneity factor provides an abstract and computational description of a set of homogeneous scenes. For example, OBJECT dimension is an illustration of a homogeneity factor. The similarity measure, on the other hand, defines how two video scenes along the homogeneity factor correlate with each other. For example, term by term matching of two SVO triplets is an illustration of a similarity measure.

Thus, a system and method for deep annotation and semantic indexing is disclosed. Although the present invention has been described particularly with reference to the figures, it will be apparent to one of the ordinary skill in the art that the present invention may appear in any number of systems that need to overcome the complexities associated with deep textual processing and deep multimedia analysis. It is further contemplated that many changes and modifications may be made by one of ordinary skill in the art without departing from the spirit and scope of the present invention.

What is claimed is:

1. A method of a deep annotation and a semantic indexing of a multimedia content based on a script, wherein said script is associated with said multimedia content, said method comprising:
determining of a plurality of multimedia scenes of said multimedia content;
determining of a plurality of script segments of said script;
obtaining of a script segment structure associated with a script segment of said plurality of script segments, wherein said script segment structure comprises: a plurality of objects, a plurality of object descriptions of said plurality of objects, a plurality of persons, a plurality of person descriptions of said plurality of persons, a plurality of locations, a plurality of location descriptions of said plurality of locations, a plurality of scene descriptions, a plurality of dialog descriptions, a plurality of action descriptions, and a plurality of directives;
determining of a plurality of closed-world key phrases based on said script;
determining of a coarse-grained annotation associated with a script segment of said plurality of script segments based on the analysis of a plurality of objects, a plurality of object descriptions of said plurality of objects, a plurality of persons, a plurality of person descriptions of said plurality of persons, a plurality of locations, a plurality of location descriptions of said plurality of locations, a plurality of scene descriptions, a plurality of dialog descriptions, a plurality of action descriptions, and a plurality of directives associated with said script segment;
determining of a plurality of coarse-grained annotations associated with a plurality of multimedia key frames of a multimedia scene of said plurality of multimedia scenes based on said plurality of closed-world key phrases;
determining of a plurality of plurality of matched script segments associated with said plurality of multimedia key frames based on said plurality of script segments and said plurality of coarse-grained annotations;
determining of a best matched script segment associated with said multimedia scene based on said plurality of plurality of matched script segments;
analyzing of said best matched script segment to result in a fine-grained annotation of said multimedia scene;
making of said fine-grained annotation a part of said deep annotation of said multimedia content;
performing of said semantic indexing of said multimedia content based on a fine-grained annotation associated with each of said plurality of multimedia scenes of said multimedia content; and
determining of a plurality of homogeneous scenes of said plurality of multimedia scenes based on said semantic indexing.

2. The method of claim 1, wherein said method of determining of said plurality of closed-world key phrases further comprising:
analyzing of a plurality of object descriptions associated with each of said plurality of script segments resulting in a plurality of object key phrases;
analyzing of a plurality of person descriptions associated with each of said plurality of script segments resulting in a plurality of person key phrases;
analyzing of a plurality of location descriptions associated with each of said plurality of script segments resulting in a plurality of location key phrases;
analyzing of a plurality of scene descriptions associated with each of said plurality of script segments resulting in a plurality of scene key phrases;
analyzing of a plurality of dialog descriptions associated with each of said plurality of script segments resulting in a plurality of dialog key phrases;
analyzing of a plurality of action descriptions associated with each of said plurality of script segments resulting in a plurality of action key phrases;
performing of consistency analysis based on said plurality of object key phrases, said plurality of person key phrases, said plurality of location key phrases, said plurality of scene key phrases, said plurality of dialog key phrases, and said plurality of action key phrases to result in said plurality of close-world key phrases.

3. The method of claim 1, wherein said method of determining of said plurality of coarse-grained annotations further comprising:
analyzing of said multimedia scene of said plurality of multimedia scenes to result in a plurality of multimedia shots;
analyzing of each of said plurality of multimedia shots to result in a plurality of multimedia key frames;
analyzing of each of said plurality of multimedia key frames based on said plurality of closed-world key phrases to result in a plurality of annotations, wherein said plurality of annotations is a part of said plurality of coarse-grained annotations;
analyzing of said plurality of annotations of said plurality of multimedia key frames to result in a multimedia shot annotation of said multimedia shot of said plurality of multimedia shots; and
analyzing of said multimedia shot annotation associated with each of said plurality of multimedia shots to result in a multimedia scene annotation associated with said multimedia scene.

4. The method of claim 1, wherein said method of determining of said plurality of plurality of matched script segments further comprising:
obtaining of a script segment of said plurality segments;
obtaining of a multimedia key frame of said plurality of multimedia key frames;
obtaining of a segment coarse-grained annotation associated with script segment, wherein said segment coarse-grained annotation is a coarse-grained annotation associated with said script segment;
obtaining of a key frame coarse-grained annotation associated with said multimedia key frame based on said plurality of coarse-grained annotations;
determining of a matching factor of said script segment based on said segment coarse-grained annotation and said key frame coarse grained annotation;
determining of a plurality of matching factors based on said plurality of script segments;
arranging of said plurality of script segments based on said plurality of matching factors in the non-increasing order to result in a plurality of arranged script segments; and
making of a pre-defined number of script segments from the top of said plurality of arranged script segments a part of said plurality of plurality of matched script segments.

5. The method of claim 1, wherein said method of determining said best matched script segment further comprising:
obtaining of said plurality of plurality of matched script segments;
determining of a plurality of isosegmental lines based on said plurality of plurality of matched script segments;
computing of a plurality of errors, wherein each of said plurality of errors is associated with an isosegmental line of said plurality of isosegmental lines;
selecting of a best isosegmental line based on said plurality of errors;
obtaining of a best script segment associated with said best isosegmental line; and
determining of said best matched script based on said best script segment.

6. The method of claim 5, wherein said method of determining said plurality of isosegmental lines further comprising:
determining of a plurality of plurality of positional weights based on said plurality of plurality of matched script segments, wherein a positional weight of said plurality of plurality of positional weights is associated with a script segment of a plurality of matched script segments of said plurality of plurality of matched script segments based on the position of said script segment within said plurality of matched script segments; and
determining of an isosegmental line of said plurality of isosegmental lines, wherein said isosegmental line is associated a plurality of segment positional weights based on said plurality of plurality of positional weights and each of said plurality of segment positional weights is associated with the same segment of said plurality of plurality of matched segments.

7. The method of claim 5, wherein said method of computing further comprising:
obtaining of an isosegmental line of said plurality of isosegmental lines;
obtaining of a plurality of segment positional weights associated with said isosegmental line;
computing of an error based on said plurality of segment positional weights and a distance measure; and
making of said error a part of said plurality of errors.

8. The method of claim 1, wherein said method of analyzing further comprising:
obtaining of a plurality of objects associated with said best matched script segment;
obtaining of a plurality of persons associated with said best matched script segment;
obtaining of a plurality of locations associated with said best matched script segment;
obtaining of a plurality of scenes associated with said best matched script segment;
obtaining of a plurality of dialogs associated with said best matched script segment;
obtaining of a plurality of actions associated with said best matched script segment;
obtaining of a plurality of key frames associated with multimedia scene;
obtaining of a description associated with an object of said plurality of objects;
obtaining of a key frame of said plurality of key frames;
obtaining of a match factor based on said description and a coarse-grained annotation associated with said key frame;
computing of a plurality of match factors associated with said plurality of key frames based on said description;
selecting of said object based on said plurality of match factors and a pre-defined threshold;
analyzing of said description to result in a plurality of subject-verb-object terms, wherein each of aid subject-verb-object terms describe a subject, an object, and a verb based on a sentence of said description; and
making of said plurality of subject-verb-object entities a part of said fine grained annotation.

9. The method of claim 1, wherein said method of determining of said plurality of homogeneous scenes further comprising:
obtaining of said plurality of multimedia scenes;
obtaining of a homogeneity factor, wherein said homogeneity factor forms the basis of said plurality of homogeneous scenes;
computing of a plurality of plurality of subject-verb-object terms based on said plurality of multimedia scenes, a plurality of fine-grained annotations, and said homogeneity factor, wherein each of said plurality of fine-grained annotations is associated with a multimedia scene of said plurality multimedia scenes;
clustering of said plurality of plurality of subject-verb-object terms into a plurality of clusters based on a similarity measure associated with said homogeneity factor; and
making of a plurality of multimedia scenes associated with a cluster of said plurality of clusters a part of said plurality of homogeneous scenes.
